(19) United States
(12) Patent Application Publication
(10) Pub. No.: US 2016/0182244 A1
(43) Pub. Date: Jun. 23, 2016

(54) Method and System for Obtaining Content Location Information Enabling Differential Charging Algorithms in Multimedia Broadcast and Multicast Service (MBMS)

(71) Applicant: Telefonaktiebolaget L M Ericsson (publ), Stockholm (SE)

(72) Inventors: David Shrader, Wilton Manors, FL (US); Saket Kumar, Bihar (IN); Thorsten Lohmar, Aachen (DE); Nipun Sharma, New Delhi (IN)

(21) Appl. No.: 14/573,915

(22) Filed: Dec. 17, 2014

(51) Int. Cl. H04L 12/18; H04W 4/24; H04W 8/20

(52) U.S. Cl. CPC H04L 12/1845; H04W 8/20; H04W 4/24; H04W 84/02

(57) ABSTRACT

The teachings herein relate to charging for multimedia content, such as Multimedia Broadcast Multicast Service, MBMS, content, that is provided for subscriber consumption through a communication network, such as a wireless communication network. One aspect of the teachings involves the advantageous inclusion of content location information in the context of generating or sending charging-related messages, in association with requested multimedia content. The content location information indicates, for example, whether the requested multimedia content is available for delivery to a subscriber device associated with the request from a data store that internal to the network. This functionality enables differentiated charging as a function of the content location indicated by the content location information included in the charging-related message.

### TECHNICAL FIELD

The present invention relates to wireless communication networks configured for delivering multimedia content, and particularly relates to providing content location information for differential charging of multimedia content.

### BACKGROUND

“Traditional” data delivery in telecommunication networks, including in cellular-based wireless communication networks, relies on point-to-point transmissions on individual connections to respective network users or subscriber. Longstanding efforts, however, aim for improved efficiencies when delivering common data to multiple users. For example, the Third Generation Partnership Project or 3GPP introduced “Multimedia Broadcast/Multicast Service” or “MBMS” technology some years ago, beginning in the “Release 6” iteration of body of technical specifications for wireless communication networks. Related work by other standards bodies may have used other names for identifying similar technologies, such as the term “BroadCast MultiCast Service” or “BCMCS”.

In the intervening years, MBMS has seen adaptations and refinements corresponding to changing wireless network architectures, protocols and capabilities. For example, MBMS in one form or another exists in the context of networks based on the Global System for Mobile Communications or “GSM” network specifications, the Wideband Code Division Multiple Access or “WCDMA” network specifications and, more recently, the Long Term Evolution or “LTE” network specifications. However, MBMS has not enjoyed wide commercialization and corresponding widespread deployment in the field.

The picture is changing, however, as a consequence of the rapid improvements in spectrum utilization efficiency and achievable data rates, and because of growing demand by consumers for the consumption of high-quality multimedia content via wireless communication networks. For example, LTE and its further evolution, referred to as “LTE-Advanced”, offer significantly higher data rates than seen in past network technologies, and work on correspondingly evolved MBMS or “eMBMS” deployments in these and future network technologies is underway.

In the context of this disclosure, unless otherwise indicated, either explicitly or implicitly by context, the term “MBMS” shall be understood as referring in an overall sense to the broader technology of multicasting/broadcasting services in wireless communication networks, in which multimedia content is broadcasted or multi-casted. Here, “multi-casting” will be understood as indicating a point-to-multipoint transmission, such as where multiple network subscribers receive the same content from a given network transmission point.

However, for comprehensive example details related to “current” MBMS architecture in the 3GPP context, the reader is referred to the technical specification identified as “3GPP TS 23.246 Multimedia Broadcast/Multicast Service (MBMS); Architecture and functional description”. This technical specification has seen multiple iterations across several releases, with “Release 12” being the most recent iteration. In its various iterations, it provides MBMS architecture details for Radio Access Networks or “RANs” using Universal Terrestrial Radio Access Network or “UTRAN” technology or the newer evolved or “E-UTRAN” technology. Here, it might be noted that the RAN part of LTE-based networks use E-UTRAN technology and the interested reader may refer to “3GPP TS 36.401 Evolved Universal Terrestrial Radio Access Network (E-UTRAN); Architecture description” for further E-UTRAN details.

Beyond matters of spectrum efficiencies and achievable data rates, communication equipment providers, network operators, and content providers still face considerable challenges in deploying MBMS-based services in a manner that provides consistently high-quality user experiences, all while balancing costs to the subscribers, the network operators, and the content operators. For example, streaming high-quality multimedia content, such as Internet Television, imposes a significant burden on wireless communication networks, both with respect to the limited capacities seen on various links in such networks, and with respect to the aggregate processing burden arising from the large-scale and routine consumption of MBMS content by the subscriber base.

One innovation of increasing interest involves multimedia content caching. Content providers have used caching techniques for some time, e.g., wherein given MBMS or other multimedia content is copied into geographically dispersed caches and then delivered from the cache having the closest or most efficient network path to the point(s) of consumption. However, at the expense of potential further complexity and content management challenges, more recent innovations push content caching further towards the “edge”, including deep into the actual delivery networks. For example, mobile network operators have or are contemplating the deployment of content caches in their “core” networks, and in some cases even in their RANs.

In non-limiting examples, the reader may refer to the following references, which in one way or another involve content caching along the lines introduced above: U.S. application Ser. No. 13/973,335 as filed on 2013 Aug. 22; U.S. application Ser. No. 14/132,478 as filed on 2013 Dec. 18; International Application WO 2014/017789 A1 as published on 2014 Jan. 30; and U.S. Pat. No. 8,467,773 B1, as issued on 2013 Jun. 18.

As is often the case in complex systems, the introduction of new capabilities brings with it further complexities and unanticipated challenges. For example, it is recognized herein that current charging assumptions and, correspondingly, current charging protocols and processing systems, are not well suited to the changing deployment and consumption scenarios seen with respect to multimedia content. Charging as generally practiced today for multimedia content consumption assesses charges, or at least accounts for network usage, based on the assumption that multimedia content is sourced external to the involved communication network. For example, details regarding an existing charging architecture and related functionality for MBMS content, the reader is referred to “3GPP TS 32.273 Telecommunication management; Charging management; Multimedia Broadcast and Multicast Service (MBMS) charging”.

### SUMMARY

The teachings herein relate to charging for multimedia content, such as Multimedia Broadcast Multicast Service, MBMS, content, that is provided for subscriber consumption through a communication network, such as a wireless communication network. One aspect of the teachings involves the advantageous inclusion of content location information in the context of generating or sending charging-related messages, in association with requested multimedia content. The content location information indicates, for example, whether the requested multimedia content is available for delivery to a subscriber device associated with the request from a data store that internal to the network. This functionality enables differentiated charging as a function of the content location indicated by the content location information included in the charging-related message.

In one example, a method is implemented in a network node that is configured for operation in a wireless communication network. The method includes receiving an access request that identifies requested multimedia content. Here, the access request is associated with a subscriber device that is operating in the network, and the method further includes determining a content location of the requested multimedia content. The determination includes at least determining whether the requested multimedia content is available for delivery to the subscriber device from a data store that is internal to the network.

The method further includes generating a charging-related message that includes content location information indicating the content location, as determined for the requested multimedia content, and sending the charging-related message to a charging node in the network. The charging-related message enables differentiated charging by the charging node as a function of the content location indicated by the content location information included in the charging-related message.

In another embodiment, a network node is configured for operation in a wireless communication network and includes a communication interface that is configured to communicate with one or more other nodes in the network, and a processing circuit that is operatively associated with the communication interface. The processing circuit is configured to receive an access request that identifies requested multimedia content, where the access request is associated with a subscriber device that is operating in the network. Further, the processing circuit is configured to determine a content location of the requested multimedia content, including at least determining whether the requested multimedia content is available for delivery to the subscriber device from a data store that is internal to the network. The processing circuit is further configured to generate a charging-related message that includes content location information indicating the content location, as determined for the requested multimedia content, and send the charging-related message to a charging node in the network. As earlier noted, the charging-related message enables differentiated charging by the charging node as a function of the content location indicated by the content location information included in the charging-related message.

In another example embodiment, a method at a charging node in a wireless communication network includes receiving a charging-related message incoming to the charging node from another node in the network. The charging related message is an accounting or credit-control request message associated with charging a subscriber account for requested multimedia content targeted for access by a subscriber device associated with the subscriber account. Correspondingly, the method includes determining whether content location information in the incoming charging-related message indicates that a content location of the requested multimedia content is internal to the network, and generating charging-related data that is differentiated in dependence on whether the content location is internal to the network.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a wireless communication network that is configured for delivery of multimedia content and illustrates example embodiments of a network node and a charging node configured according to the teachings herein.

FIGS. 2 and 3 are diagrams of example embodiments of a database arrangement, for use in maintaining content location information for at least some of the multimedia content available to subscriber devices through a wireless communication network.

FIG. 4 is a logic flow diagram of one embodiment of a method of determining and indicating content location for requested multimedia content, to a charging node in a wireless communication network.

FIGS. 5 and 6 are block diagrams of example embodiments of a charging node configured to receive and multimedia content location information.

FIG. 7 is a block diagram of another embodiment of a wireless communication network that is configured for delivery of multimedia content and illustrates further example embodiments of a BM-SC node and a charging node configured according to the teachings herein.

FIGS. 8 and 9 are signaling flow diagrams of example signaling embodiments involving a BM-SC and a charging node, according to the teachings herein.

FIG. 10 is a diagram of one embodiment of a message structure, for use, for example, in conveying content location information for requested multimedia content, from a BM-SC to a charging node.

FIG. 11 is a logic flow diagram of one embodiment of a method of operation in a charging node.

### DETAILED DESCRIPTION

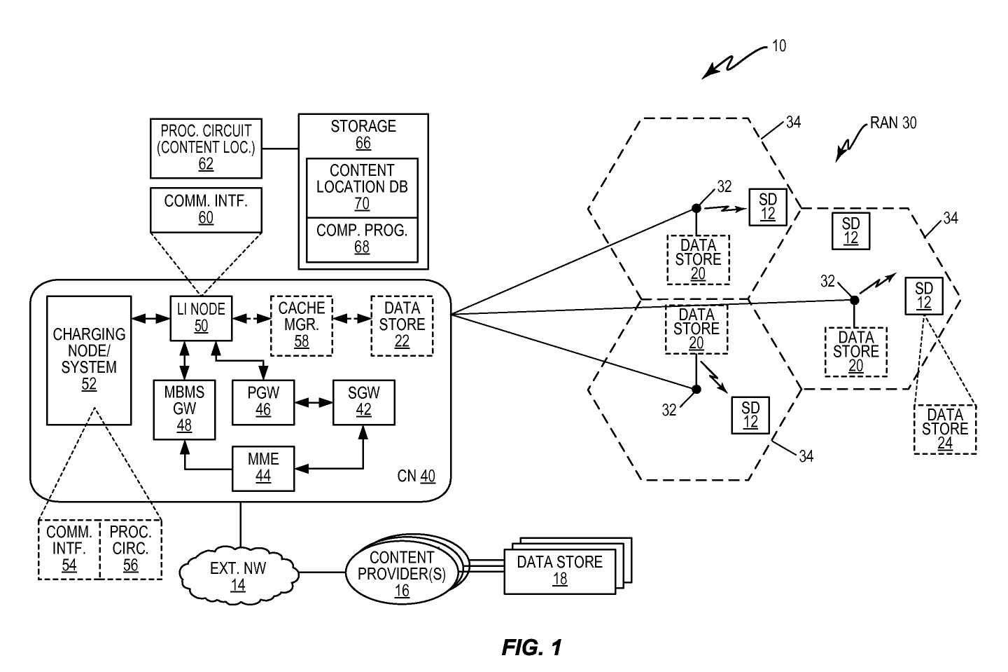

FIG. 1 illustrates an example embodiment of a wireless communication network 10, referred to hereafter as the “network 10”. In a non-limiting example the network 10 is a cellular telecommunications network configured according to the Long Term Evolution or “LTE” specifications, or is another type of cellular network. The network 10 provides communication services to subscriber devices 12, including offering subscribers the opportunity to view or otherwise consume multimedia content. For example, the network 10 is configured to provide Multicast/Broadcast Multimedia Services, which make various Multicast/Broadcast Multimedia Service or “MBMS” content available to subscribers.

However, the network 10 in some embodiments provides multimedia content using point-to-point transmissions in addition to or as an alternative to using broadcast or multicast transmissions, such as MBMS, for multimedia content delivery. In both contexts, i.e., in broadcast/multicast scenarios and in point-to-point transmission scenarios, the teachings herein provide an advantageous mechanism for differentiated charging based on the “location” of the multimedia content to be delivered. Further, without implying any definitional restrictions, multimedia content comprises, for example, Internet TV, streaming movies, web videos, and the like.

Multimedia content may be sourced, at least initially, through one or more external networks 14—e.g., the Internet—and is provided by various content provider servers 16 having associated data stores 18. However, the network 10 includes one or more “internal” data stores that are used at least temporarily to cache at least certain multimedia content. As one example, the network 10 includes any one or more of the following internal data stores: data stores 20, data stores 22, and data stores 24. Individual items of multimedia content thus may be pulled from external data stores 18 and cached internally within the network 10 in any one or more of data stores 20, 22 and 24. Internal caching can improve the user experience when delivering the cached content to subscriber devices 12, and improve efficiency and/or lower bandwidth and capacity requirements for the network 10.

The network-relevant “locations” of these internal data store examples will be detailed below, but those details will be better understood after further detailing the example network architecture. According to the depicted architecture, the network 10 inlcudes a Radio Access Network or RAN 30. The RAN 30 provides the “air interface” or radio connectivity used to connect subscriber devices 12 to the network 10 and beyond, and generally includes a number of radio transceivers, which are generically referred to herein as “base stations 32”. Use of this term, however, does not preclude the use of so called “access points”, relays, etc.

Each base station 32 provides communication services in a corresponding geographic area, where the provisioning or use of given air interface resources to provide such services in the corresponding service or coverage area defines a “cell 34”. The RAN 30 generally provides a number of cells 34, which may be overlapping. While depicted as being uniform in size, the RAN 30 may comprise a homogeneous radio network having the same type of base stations 32 offering comparable power, coverage and service capabilities, or may comprise a heterogeneous radio network having a mixed type of base stations 32, e.g., larger-scale “macro” base stations and smaller-scale “micro”, “pico” and/or “femto” base stations, such as low-power access points, private Home NodeBs, etc. Note, too, that given base stations 32 may use different radio resources to provide more than one cell 34 per base station. For example, a given base station 32 may use two or more carrier frequencies or even different Radio Access Technologies or “RATs” to provide two or more cells 34.

The RAN 30 couples—e.g., via a wired or wireless backhaul—to a Core Network or “CN” 40. The depicted CN 40 includes a number of example nodes, and in actual implementation may include further nodes not shown and/or may include other types of nodes in place of the example depictions, in dependence on the type of network and its features. Moreover, although some of the depicted nodes carry labels associated with particular network technologies, e.g., LTE, these details are exemplary and for purposes of discussion, rather than being intended as limiting.

With those points in mind, the example CN 40 includes one or more Serving Gateways or “SGWs” 42, one or more Mobility Management Entities or “MMEs” 44, a Packet Gateway or “PGW” 46, and a MBMS Gateway or “MBMS GW” 48. Further, the example CN 40 includes a network node 50, which may be any one of various types of nodes, and which is referred to herein more generically as a Location Information or “LI” node 50, to emphasize its use in generating and sending the location information advantageously included in charging-related messages, for enabling differentiated charging for requested multimedia content in dependence on the location from which the requested multimedia content is provided.

The LI node 50 provides the above-described charging-related messages to a charging node or system 52, that includes a communication interface 54 configured for communicating with one or more other network nodes, e.g., at least the LI node 50. The charging node 52 further includes a processing circuit 56 that is configured according to the charging-node configurations described herein.

For ease of reference, and to emphasize its associated implementation flexibility, the LI node 50 is hereafter referred to simply as the “network node 50”. The network node 50 may interface directly or indirectly with other nodes in the network 10, such as a Cache Manager 58. Further, the network node 50 may interface, at least indirectly, with the base stations 32 and/or with other nodes in the RAN that are not explicitly illustrated in FIG. 1. In support of these related communications and the overall node functionality described herein for the network node 50, an example implementation of the network node 50 includes a communication interface 60, a processing circuit 62 and storage 66 that stores, for example, a computer program 68 and a content location database 70.

The communication interface 60 is configured to communicate with one or more other nodes in the network 10, such as any one or more of the nodes 32, 46, 48, 52 and 58. The processing circuit 62 is operatively associated with the communication interface 60 and is configured to receive an access request that identifies requested multimedia content, where the access request is associated with a subscriber device 12 that is operating in the network 10. Correspondingly, the processing circuit 62 is configured to determine a content location of the requested multimedia content, including at least determining whether the requested multimedia content is available for delivery to the subscriber device 12 from a data store that is internal to the network 10. Still further, the processing circuit 62 is configured to generate a charging-related message that includes content location information indicating the content location, as determined for the requested multimedia content, and send the charging-related message to a charging node 52 in the network 10, to enable differentiated charging by the charging node 52 as a function of the content location indicated by the content location information included in the charging-related message.

As an example, the network 10 includes one or more data stores 20 residing in the RAN 30. If the requested multimedia content is available for delivery to the subscriber device 12 from a data store 20 in the RAN 30, then that content is considered as being internally available. Additionally, or alternatively, the network 10 includes one or more data stores 22 residing in the CN 40. If the requested multimedia content is available for delivery to the subscriber device 12 from a data store 22 in the CN 40, then that content is considered as being internally available. Additionally, or alternatively, the subscriber device 12 at issue may include a data store 24 holding a copy of the requested multimedia content that is “available”—e.g., still valid or fresh, appropriately authorized, etc.—then that content is considered as being internally available.

As such, it will be understood that, unless otherwise qualified explicitly or by the specific context, a data store is at least logically “internal” to the network 10 for purposes of this disclosure if the data store is anywhere within the network proper, or is otherwise captive to and controlled by the network, or if the data store is in the particular subscriber device(s) 12 involved in the multimedia content request. The data stores 20 and 22 are examples of data stores that are physically and functionally within the network 10. While the data store 24 shown in FIG. 1 is physically in a given subscriber device 12, it is also considered as being at least logically internal to the network 10, inasmuch as signaling from the network 10 may be used to grant or control access to content stored therein.

For example, a subscriber device 12 includes a data store 24 that is used to cache multimedia content, possibly multiple items of multimedia content, which may or may not be consumed by a user of the subscriber device 12. To the extent that consumption occurs, the teachings herein can be used to generate a charging-related message that reflects the fact that the multimedia content involved in that consumption event was sourced from the data store 24 of the subscriber device 12 involved in the consumption. Such information may be used for differentiated charging, e.g., charging a lower rate for the consumption. Such logic holds even where the multimedia content is sourced originally from an external data store 18. For example, the particular multimedia content at issue may be pushed or pulled to the subscriber device 12 in a manner that eliminates or reduces strain on the network 10 when it is cached in the data store 24 of the subscriber device, meaning that charging for its later consumption from the data store 24 ought to reflect this lower burdening of the network 10.

In one example, the multimedia content at issue is transmitted to the subscriber device 12 for caching in the data store 24 during off-peak hours, or when the subscriber device 12 is operating in a cell 34 that is otherwise being underutilized. Additionally, or alternatively, the multimedia content may have been transmitted through another broadband connection, such as through a WiFi hotspot associated with the operator of the network 10 or even with a third-party Internet Service Provider.

With these possibilities for the data stores at issue in mind, the processing circuit 62 in an example embodiment is configured to determine whether the requested multimedia content is available for delivery to the subscriber device 12 from a data store 20, 22, or 24 that is internal to the network 10 by determining availability based on a location of the subscriber device 12 within the network 10. Consider scenario involving one or more data stores 22 in the RAN 30. For example, it may be that each base station 32 includes or is associated with an associated data store 20.

In a restrictive case, the requested multimedia content would not be considered as being available for delivery to the subscriber device 12, unless a copy of the requested multimedia content was in the data store 20 associated with the base station 32 currently serving the subscriber device 12. This restrictive configuration is predicated on the assumption that sourcing the requested multimedia content from a data store 20 other than the one directly associated with the serving base station 32 is undesirable. This evaluation can be understood as evaluating the location of the involved subscriber device 12, at least in terms of which cell 34 is being used to serve the subscriber device 12. Of course, in reality, this restrictive assumption may or may not hold, in dependence on the sidehaul path between the serving base station 32 and the data store 20 from which the requested multimedia content would be sourced. Notably, the cache manager 58 may control or otherwise manage multiple data stores 20 in the RAN 30, to keep copied, cached content updated, broadly distributed within the RAN 30, etc.

In a less restrictive case, the requested multimedia content would be considered as being available from an internal data store if any data store 20 in the RAN 30 held a usable copy of the requested multimedia content. In a refinement of that approach, the requested multimedia content would be considered as being internally available if any data store 20 within a certain geographic distance, cell distance, or network-hop distance, held a usable copy. Of course, it is contemplated herein that the network node 50 may be configured to always apply the restrictive-case evaluation, or to always apply the less-restrictive-case evaluation, or to select which case logic to apply in dependence on dynamic factors, such involved-cell loading, sidehaul link loading and capacities, etc.

In implementations where the network 10 includes one or more data stores 22 in the CN 40 instead of data stores 20 in the RAN 30, the network node 50 may consider any and all multimedia content cached at a CN-level data store 22 as being “internally” available for delivery to any given subscriber device 12 connected through the RAN 30. In other embodiments, the evaluation is more nuanced and includes considerations of any one or more of: the geographic location or at least “network” location of the involved subscriber device 12; the amount or nature of the content, etc.

Broadly, in some embodiments, the processing circuit 62 is configured to determine availability based on the location of the subscriber device 12 within the network 10 by determining whether the requested multimedia content is indicated as being available from an internal cache associated with a service area of the subscriber device 12 within the network 10. As explained, each base station 32 may have an associated data store 20, such that each of its one or more cells 34 would be service areas for which multimedia content stored in the associated data store 20 would be considered as being available internally from within the network 10. Moreover, there may be quasi-centralized data stores 20 within the RAN 30, where each such data store 20 serves as a cache for more than one base station 32 and/or more than one service area and where the evaluations of internal availability are accordingly adjusted to reflect the expanded “coverage” of each such data store 20.

In at least some embodiments, the processing circuit 62 is configured to determine whether given requested multimedia content is available for delivery to involved subscriber device 12 from a data store 20, 22 or 24 that is internal to the network 10 by accessing the aforementioned content location database 70. In at least one such embodiment, the content location database 70 includes content location data for at least some of the multimedia content available through the network 10. In these embodiments, the processing circuit 62 determines whether the content location data indicates that the requested multimedia content is available for delivery to the subscriber device 12 from a data store 20, 22 or 24 that is internal to the network 10.

Further, in at least one such embodiment, the processing circuit 62 is configured to maintain the content location database 70 for at least a portion of the network 10. For example, the processing circuit 62 maintains the content location database 70, based on receiving indications from one or more network entities within the network 10 as to which particular multimedia content is internally cached within the network 10 and updating the content location database 70 according to the received indications. The processing circuit 62 is configured to receive the indications from the one or more network entities based on at least one of the following: communicating with a cache manager 58, also referred to as a “cache management entity 58”; communicating with one or more radio base stations 32 in the network 10; and communicating with one or more data stores in the network 10, such as data stores 20 and/or 22. Communicating with data stores in this sense is applicable when they are implemented as intelligent nodes having control and communications capabilities, rather than simply as captive storage slaved to a base station 32 or other entity. Also, note that references to base stations 32 also encompasses communications with base station controllers or the like, and the particular nodes or entities involved in maintaining the content location database 70 will depend on the network details and involved standards.

The cache manager 58 in some sense represents an ideal source of such information, at least in cases where it plays a centralized role in determining which multimedia content gets cached in which data stores, and in maintaining and updating such caching. The cache manager 58 also has, at least in some implementations, involvement in prefetching multimedia content into data stores 24 at respective subscriber devices 12, and thus has visibility into the particular multimedia content stored in any given subscriber device 12 at any given time.

Regardless of where or how the content location database 70 is held, stored and maintained, the processing circuit 62 in one or more embodiments is configured to determine the content location of the requested multimedia content by determining whether, in a first case, the requested multimedia content is not indicated as being internally available within the network 10 for delivery to the subscriber device 12, or determining that, in a second case, the requested multimedia content is indicated as being internally available within the network 10 for delivery to the subscriber device 12. The processing circuit 62 in such embodiments is further configured to control the content location information included in the charging-related message to indicate whether the first case or the second case applies.

Further, in at least one such embodiment, if the second case applies, the processing circuit 62 is configured to control the content location information included in the charging-related message so as to indicate whether the requested multimedia content is to be delivered to the subscriber device 12 from a data store 20 in RAN 30 portion of the network 10 or from a data store 22 in a CN 40 portion of the network 10. Along the same lines, in embodiments that use or are aware of data stores at the subscriber-device level, e.g., the data store 24 shown in FIG. 1, the charging-related message may indicate that the requested multimedia content is to be delivered from a data store 24 at the involved subscriber device 12.

Thus, as a general proposition, the content location information included in the charging-related message may simply indicate whether or not the requested multimedia content is to be delivered from a data store that is internal to the network 10. Even this “coarse” level of location indication allows the charging node 52 to differentiate charging for multimedia content that is delivered from an internal data store 20, 22 or 24 versus multimedia content that is delivered from an external data store 18.

Finer gradations or “richer” content location information is also contemplated. Such as where the content location information uses multiple values or additional or different indicators, to differentiate between the cases where the data store from which the requested multimedia content is to be delivered is at the CN level or at the RAN level. Further distinctions may be made to indicate whether the requested multimedia content is to be delivered from a data store 22 that is directly associated with the current service area of the subscriber device 12, or from a data store 22 that is outside the current service area. Additionally, the content location information may identify instances in which the requested multimedia content is to be delivered from a data store 24 contained within the involved subscriber device 12. Thus, when the requested multimedia content is available internally within the network 10 for delivery to the subscriber device 12, the processing circuit 62 in some embodiments is configured to control the content location information in the charging-related message to indicate a cache identifier or a more particularized internal location indicator, which indicates the identity or at least type of internal data store 20, 22, or 24 within the network 10 from which the requested multimedia content is to be delivered. Here, “type” may be defined as “RAN type”, “CN type”, “Device type”.

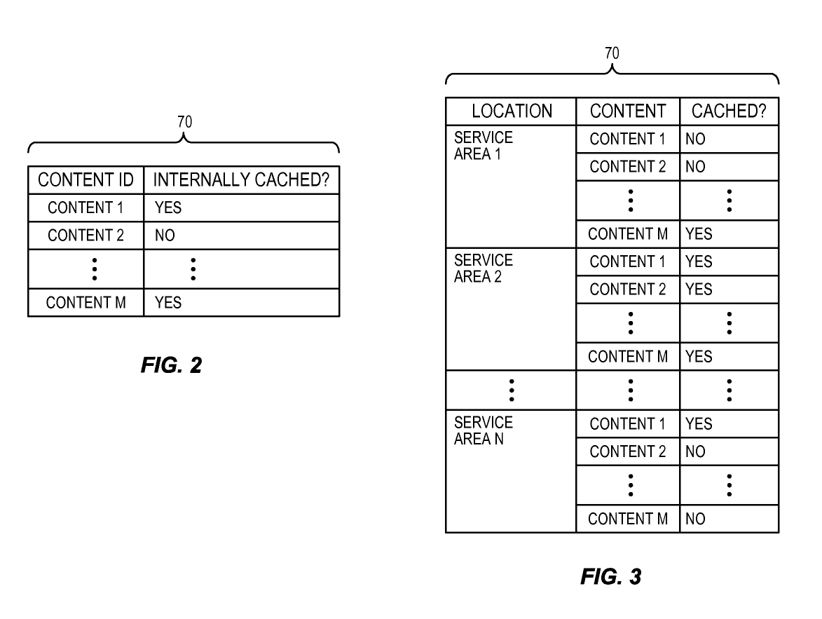

FIGS. 2 and 3 illustrate example implementations of the content location database 70. The example of FIG. 2 provides for coarse indications of whether or not given multimedia content is or is not cached internally. For example, certain popular or previously requested TV shows, movies, videos, etc., are cached internally, while other less popular content can be provided through the network 10 but is available only from external data stores 18. In the example of FIG. 2, a particular item of multimedia content, “CONTENT 1”, has a database entry marking it as being internally cached, while “CONTENT 2” has an entry marking it as not being internally cached. These entries may be distinguished according to content identifiers, such as the content names, links, or identification numbers or codes used by subscriber devices 12 to request particular multimedia content from the network 10.

FIG. 3 expands the approach seen in FIG. 2, by including content caching indications on a per service area basis. Here, the network 10 may be divided into service areas, which may be custom definitions, or which may match MBMS service area boundaries, cell boundaries, paging area boundaries, etc. In either case, the determination as to whether requested multimedia content is available for delivery from internal data storage depends on whether the content is available in the involved service area. Thus, the processing circuit 62 may use cell IDs or other service area identifiers to determine the relevant service area for a given multimedia content request, and then index into the content location database 70 according to the indicated service area, to determine availability for the indicated service area.

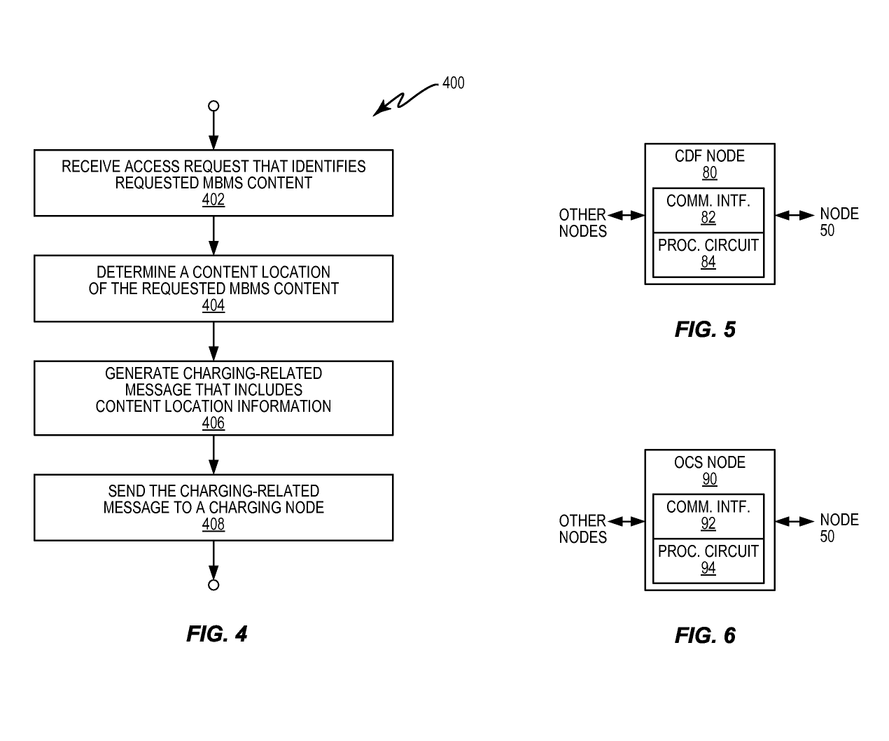

FIG. 4 illustrates a method 400, such as may be implemented by the network node 50. For example, the processing circuit 62 of the network node 50 comprises one or more microprocessors, digital signal processors, Field Programmable Gate Arrays or “FPGAs”, Application Specific Integrated Circuit or “ASICs”, or other digital processing circuitry. At least some such circuitry is programmed circuitry, e.g., via the execution of stored computer program instructions from the computer program 68 shown in FIG. 1. In such arrangements, the storage 66 comprises a computer-readable medium, or multiple computer-readable media, and provides non-transitory storage for the computer program 68, for execution by the digital processing circuitry of the illustrated processing circuit 62. Here, “non-transitory” does not necessarily mean permanent or fixed storage, but does exclude the mere propagation of a carrier wave. In one example, the storage 66 includes a hard disk, a solid-state disk, such as based on FLASH memory, and further includes DRAM or other working memory.

However the network node 50 is implemented, the example method 400 includes receiving (Block 402) an access request that identifies requested multimedia content, said access request being associated with a subscriber device 12 that is operating in the network 10. The method 400 further includes determining (Block 404) a content location of the requested multimedia content, including at least determining whether the requested multimedia content is available for delivery to the subscriber device 12 from a data store 20, 22, or 24 that is internal to the network 10, and generating (Block 406) a charging-related message that includes content location information indicating the content location, as determined for the requested multimedia content. The method 400 further includes sending (Block 408) the charging-related message to a charging node 52 in the network 10, to enable differentiated charging by the charging node 52 as a function of the content location indicated by the content location information included in the charging-related message.

The nature of the charging-related message depends on the particulars of the charging node 52. For example, the processing circuit 62 is configured to generate the charging-related message as an accounting request message for a Charging Data Function, CDF, node as said charging node 52, or to generate the charging-related message as an credit control request message for an Online Charging System, OCS, node as said charging node 52.

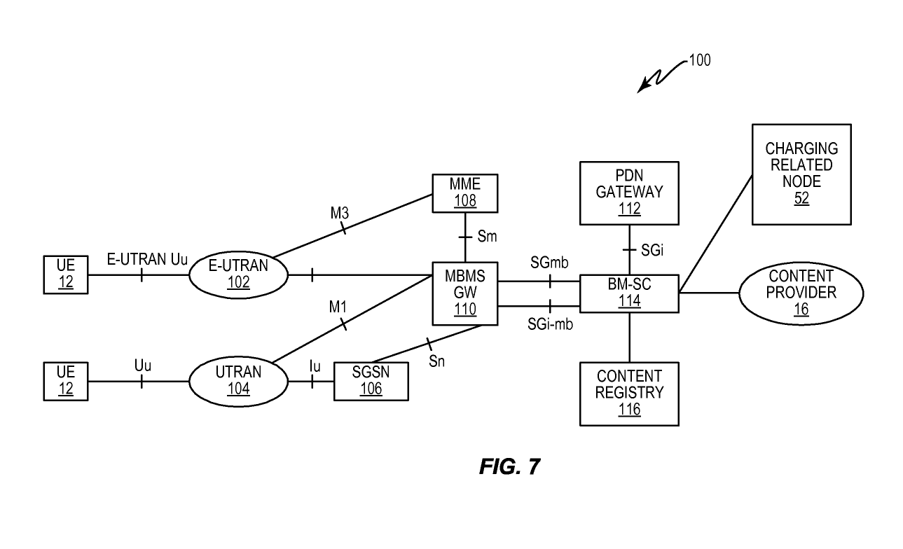

The CDF-based example is seen in FIG. 5, wherein a CDF node 80 includes a communication interface 82 and a processing circuit 84. These elements can be understood as specific examples of the aforementioned communication interface 54 and processing circuit 56 shown in FIG. 1 for the charging node 52. Similarly, the OCS-based example is seen in FIG. 6, wherein an OCS node 90 includes a communication interface 92 and a processing circuit 94. These elements can be understood as specific examples of the aforementioned communication interface 54 and processing circuit 56 shown in FIG. 1 for the charging node 52.

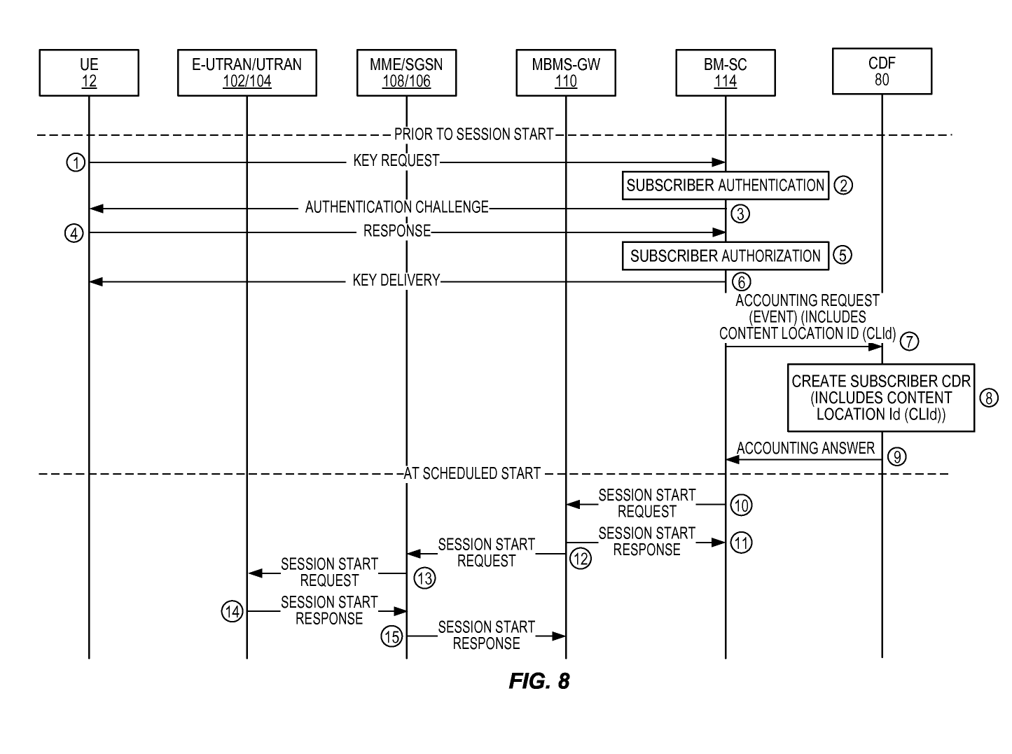

FIG. 7 illustrates another embodiment of a wireless communication network 100, which can be understood as a more detailed or alternative version of the network 10 introduced in FIG. 1. The network 100 includes two RANs; namely, a E-UTRAN 102 and a UTRAN 104, along with various related CN nodes, including a Serving Generalized Packet Radio Services Gateway Node or “SGSN” 106, a MME 108, a MBMS GW 110, a Packet Data Network or “PDN” GW 112, a Broadcast/Multicast Service Center or “BM-SC” 114, and a content registry 116. Here, the subscriber devices 12 are denoted as “UEs” or “user equipments”.

In this context, the BM-SC 114 is configured, for example, to operate as the previously described network node 50. For example, incoming requests for multimedia content may be received via the SGmb and/or SGi-mb interfaces, and the charging-related messages may be output to the charging node 52 via another interface link. The content registry 116, which may be captive under or simply communicatively coupled to the BM-SC 114, is a server, data store, or other entity that contains the aforementioned content location database 70.

In dependence on the particular caching arrangement used and the particular requested multimedia content, such content is available internally or it has to be fetched from an authorized external or remote content provider 16. The BM-SC 114 is responsible for generating the charging event towards CDF node 80/OCS node 90, depending upon the Rf/Ro Interface. Charging information generated by the BM-SC node 114 include S-BMSC-CDR and C-BMSC-CDR signaling for subscriber and content provider charging, respectively. For every MBMS bearer, the BM-SC 114 is aware of the location of involved multimedia content either through communication with MBMS-GW 110 or a Content Manager. The BM-SC 114 sets the content location information to a predefined value for each of the possible cases representing the logical location of the involved multimedia content.

The content location information included in the charging-related message(s) may be a parameter denoted as “CL ID”, for content location identifier. The CL ID parameter may be defined to have a first value to indicate that the content is available from an internal data store 20, 22 or 24, and a second value to indicate that the content is not available from an internal data store 20, 22 or 24. A “null” value or missing value could be used for such indication. In a further refinement, the CL ID may be defined to have different values or subsets of values, in dependence on whether the internal data store in question is a RAN-based data store 20, a CN-based data store 22, or a device-based data store 24. Still further, the CL ID or supplemental information provided therewith, may be defined to have values indicating more nuanced cases, such as where a preferred internal data store does not have the requested multimedia content, but the same content is available from a less preferred internal data store. These circumstances may arise, e.g., in the case of RAN-based caching. In any case, the CL ID parameter would be available in both the Offline as well as Online Charging scenarios, i.e., on both the Rf and Ro interfaces.

In one approach to maintaining current content location information for various items of multimedia content, the BM-SC 114 periodically queries the base stations 32, or some node having knowledge of the contents of RAN-based data stores 20 that are operated in association with the respective base stations 32. Additionally, or alternatively, the base stations 32 are configured to periodically send cache content reports to the BM-SC 114. In either case, the BM-SC 114 updates the content registry 116, to reflect the current caching information. Of course, more generally, the network node 50, whether or not it operates as the BM-SC 114, may perform these functions. Further, if a cache manager 58 is implemented in the network 10, the cache manager 58 may perform cache management or at least have an awareness of the content in the relevant data stores 20, 22, and 24. In such embodiments, the network node 50 maintains the content location database 70 based on receiving content location information from the cache manager 58, or the cache manager 58 directly maintains the content location database 70.

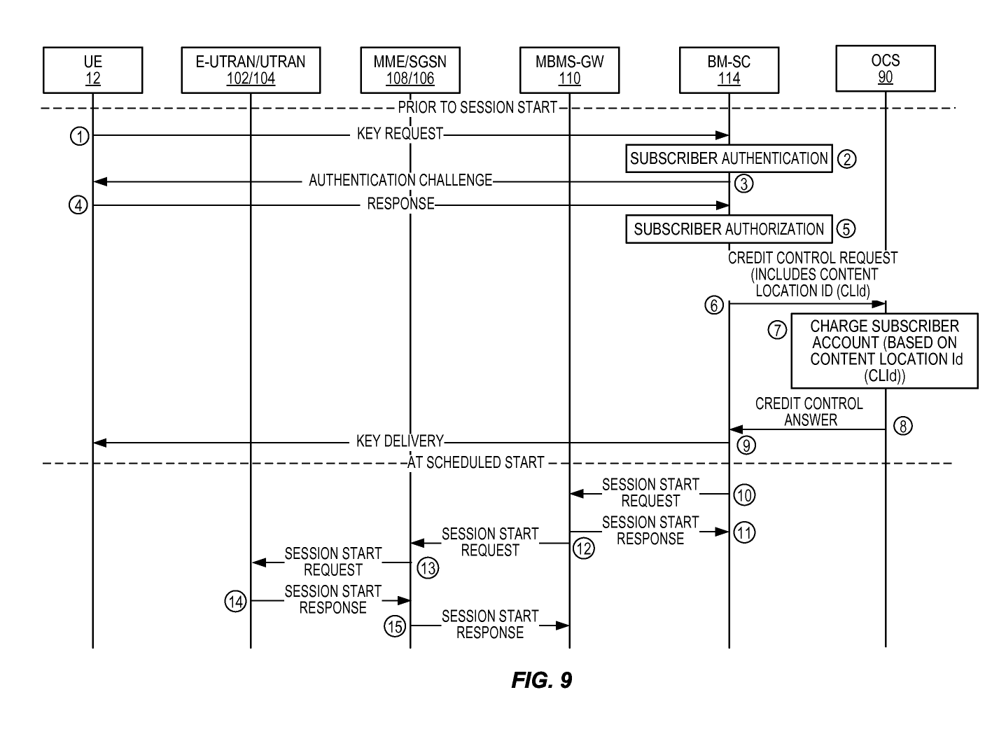

FIG. 8 provides an example signal flow relevant to the entities illustrated in the network 100, but involves the specific example of the charging node 52 comprising a CDF node 80. At step 1, the subscriber device 12, which may be a UE in the 3GPP parlance, sends a key request to the BM-SC 114. The key request requests an authentication key or other data needed for a particular item of multimedia content. The BM-SC 114 performs subscriber authentication at step 2, which results in the BM-SC 114 sending an authentication challenge to the subscriber device 12 at step 3, and receiving an authentication response in return at step 4.

Assuming successful subscriber authorization in step 5, the flow continues with delivering the requested key to the subscriber device 12 at step 6. At step 7, the BM-SC 114 sends an Accounting Request message to the CDF node 80, where this message can be understood as an example of earlier-described charging-related message. As such, the message includes some form of content location identifier, denoted as a “CL ID” in the diagram.

To understand how the CL ID was determined, consider that the key request received at step 1 provides enough information to identify the particular multimedia content being requested, which is indicated by the value of the key being requested, and to identify the relevant location of the requesting subscriber device 12. Alternatively, if the key request does not include MBMS service area identifiers, serving cell identifiers, or the like, it prompts the BM-SC 114 to query for relevant location information. Still further, in embodiments, the subscriber device 12 location is not needed, e.g., where the BM-SC 114 needs only determine whether the requested multimedia content is or is not in a CN-level data store 22.

In any case, for the identified, requested multimedia content, the BM-SC 114 accesses the content location database 70, to determine whether the database indicates that the requested multimedia content is stored internally within the network 100. At step 8, the CDF 80 generates a subscriber CDR that contains the CL ID or information derived therefrom, and at step 9 the CDF 80 returns an Accounting Answer to the BM-SC 114.

The signal flow continues at the scheduled start of the session, including sending a Session Start Request from the BM-SC 114 to the MBMS-GW 110 at step 10, and receiving a return response at step 11. Corresponding session start requests and responses are seen at steps 12-15, involving the MBMS-GW 110, MME 108 and/or SGSN 106, and E-UTRAN 102 and/or UTRAN 104.

A similar set of steps 1-15 are seen in FIG. 9. However, the signal flow of FIG. 9 involves an OCS node 90 as the charging node 52. Consequently, the charging-related message that is sent from the BM-SC 114 at step 6 is a Credit Control Request message. As with the Accounting Request message shown in FIG. 8, the Credit Control Request message includes content location information, e.g., a CL ID value, which indicates whether the requested multimedia content is or is not available for delivery to the subscriber device 12 from an internal data store 20, 22 or 24.

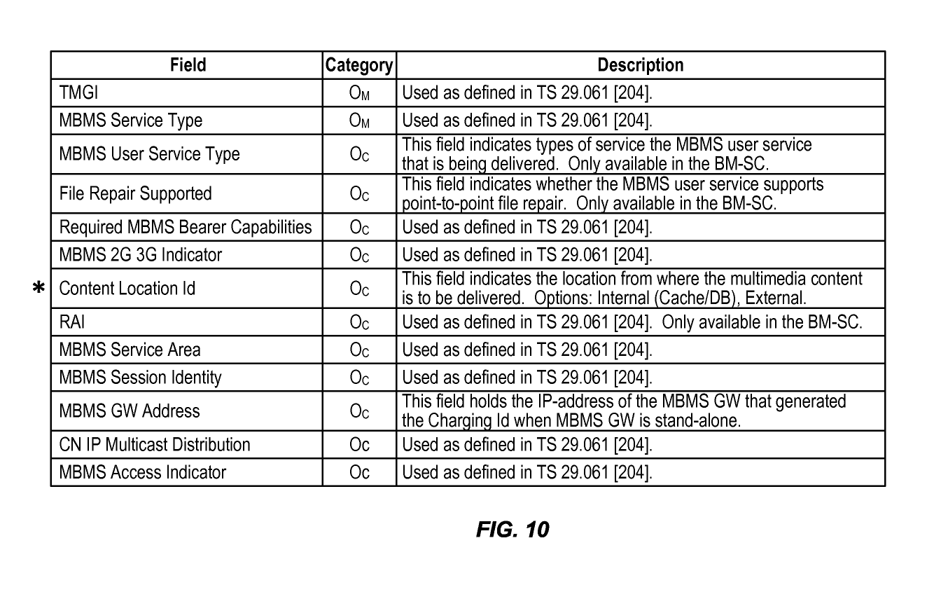

In another example related to adapting or revising preexisting nodes, protocols and messaging, FIG. 10 illustrates a modified version of Table 6.3.1.2.1 as seen in 3GPP TS 32.273 version 12.0.0, Release 12. The preexisting table illustrates the structure of MBMS information used in charging and the modified version of FIG. 10 illustrates the addition of content location—denoted by the asterisk—to the MBMS information. While the other, preexisting data items shown in the table need not be explained in this discussion, the interested reader can find their meanings in TS 32.273.

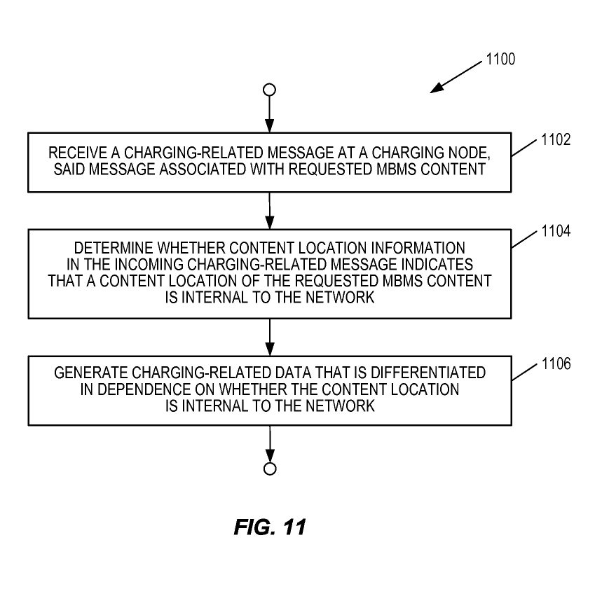

Further regarding the charging node 52 and its related functionality, whether operating as a CDF node 80 or as an OCS node 90, FIG. 11 illustrates an example method 1100 implemented at a charging node 52. The method 1100 includes receiving (Block 1102) a charging-related message incoming to the charging node 52 from another node 50 in the network 10, said charging related message comprising an accounting or credit-control request message associated with charging a subscriber account for requested multimedia content targeted for access by a subscriber device 12 associated with the subscriber account. The method 1100 further includes determining (Block 1104) whether content location information in the incoming charging-related message indicates that a content location of the requested multimedia content is internal to the network 10, and generating (Block 1106) charging-related data that is differentiated in dependence on whether the content location is internal to the network 10.

In an example embodiment, generating (Block 1106) the charging-related data comprises generating the charging-related data according to a differentiated pricing structure, where first rates or charges apply in the case that the content location is indicated as being internal to the network 10, and second rates or charges apply in the case that the content location is not indicated as being internal to the network 10. In the same or a further embodiment, in the case that the content location is indicated as being internal to the network 10, the method 1100 includes generating the charging-related data so as to differentiate between the content location being internal to a RAN 30 portion of the network 10, or the content location being internal to a CN 40 portion of the network 10.

With the above features and operations in mind, the teachings herein provide for a location-based approach to content pricing, where “location” as used in this sense broadly means the location of the data store from which the content is to be delivered. A top-level location distinction is determining whether the content delivery involves a data store that is logically internal to the network in question, or one that is external to the network. Further distinctions may be made regarding the location of an internal data store, such as distinguishing whether the internal data store from which the content is to be delivered is CN-based or RAN-based. In at least some cases, further distinctions are made to identify cases where the internal data store is device-based. Still further distinctions are made in at least some embodiments, such as indicating whether the internal data store from which the content is available is a preferred or non-preferred data store with respect to the contemplated content delivery.

Regardless of these implementation details, the teachings presented herein enable network operators to use differentiated pricing based on where given requested multimedia content is cached, which avoids the limitations of current approaches to rating and pricing multimedia services that do not account for cache location. Including content location information in the charging-related messages generated in association with a multimedia content request enables the network operator to apply differential charging, based on the content location information, e.g., discounted charging for cases where the content is indicated as being sourced from a data store internal to the network.

The content location information thus provides a mechanism to reduce the control of Over-The-Top or “OTT” Content Providers on the multimedia content. For example, a network operator could maintain recent or popular movies in one or more internal data stores and charge a discounted rate for delivering internally-cached movies to subscribers, while charging the standard data rates for OTT-based content delivery. Price differentiation along these lines in turn encourages the subscribers to favor multimedia content that is available from an internal data store, thereby leading to more efficient network utilization and, ultimately, lower capital and operating expenditures for the network operator.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-24. (canceled)

25. A method in a network node configured for operation in a wireless communication network, said method comprising:
receiving an access request that identifies requested multimedia content, said access request being associated with a subscriber device that is operating in the network;
determining a content location of the requested multimedia content, including at least determining whether the requested multimedia content is available for delivery to the subscriber device from a data store that is internal to the network;
generating a charging-related message that includes content location information indicating the content location, as determined for the requested multimedia content; and
sending the charging-related message to a charging node in the network, to enable differentiated charging by the charging node as a function of the content location indicated by the content location information included in the charging-related message.

26. The method of claim 25, wherein determining whether the requested multimedia content is available for delivery to the subscriber device from a data store that is internal to the network comprises determining availability based on a location of the subscriber device within the network.

27. The method of claim 26, wherein determining availability based on the location of the subscriber device within the network comprises determining whether the requested multimedia content is indicated as being available from an internal cache associated with a service area of the subscriber device within the network.

28. The method of claim 25, wherein determining whether the requested multimedia content is available for delivery to the subscriber device from a data store that is internal to the network comprises accessing a content location database that includes content location data for at least some of the multimedia content available through the network, and determining whether the content location data indicates that the requested multimedia content is available for delivery to the subscriber device from a data store that is internal to the network.

29. The method of claim 28, further comprising maintaining the content location database for at least a portion of the network, based on receiving indications from one or more network entities within the network as to which particular multimedia content is internally cached within the network and updating the content location database according to the received indications.

30. The method of claim 29, wherein receiving the indications from the one or more network entities comprises at least one of: communicating with a cache management entity in the network and communicating with one or more radio base stations or base station controllers in the network.

31. The method of claim 25, wherein determining the content location of the requested multimedia content comprises determining whether, in a first case, the requested multimedia content is not indicated as being internally available within the network for delivery to the subscriber device, or determining that, in a second case, the requested multimedia content is indicated as being internally available within the network for delivery to the subscriber device, and wherein the method includes controlling the content location information included in the charging-related message to indicate whether the first case or the second case applies.

32. The method of claim 31, wherein, in the second case, the method further includes controlling the content location information to indicate whether the requested multimedia content is to be delivered to the subscriber device from a data store in a Radio Access Network, RAN, portion of the network or from a data store in a Core Network, CN, portion of the network.

33. The method of claim 25, wherein, when the requested multimedia content is available internally within the network for delivery to the subscriber device, the method includes controlling the content location information in the charging-related message to indicate a cache identifier or location for the internal data store within the network from which the requested multimedia content is to be delivered.

34. The method of claim 25, wherein generating and sending the charging-related message comprises one of:
generating the charging-related message as an accounting request message and sending the accounting request message to a Charging Data Function, CDF, node as said charging node; and
generating the charging-related message as a credit control request message and sending the credit control request message to an Online Charging System, OCS, node as said charging node.

35. A network node configured for operation in a wireless communication network, said network node comprising:
a communication interface configured to communicate with one or more other nodes in the network; and
a processing circuit operatively associated with the communication interface and configured to:
receive an access request that identifies requested multimedia content, said access request being associated with a subscriber device that is operating in the network;
determine a content location of the requested multimedia content, including at least determining whether the requested multimedia content is available for delivery to the subscriber device from a data store that is internal to the network;
generate a charging-related message that includes content location information indicating the content location, as determined for the requested multimedia content; and
send the charging-related message to a charging node in the network, to enable differentiated charging by the charging node as a function of the content location indicated by the content location information included in the charging-related message.

36. The network node of claim 35, wherein the processing circuit is configured to determine whether the requested multimedia content is available for delivery to the subscriber device from a data store that is internal to the network by determining availability based on a location of the subscriber device within the network.

37. The network node of claim 36, wherein the processing circuit is configured to determine availability based on the location of the subscriber device within the network by determining whether the requested multimedia content is indicated as being available from an internal cache associated with a service area of the subscriber device within the network.

38. The network node of claim 35, wherein the processing circuit is configured to determine whether the requested multimedia content is available for delivery to the subscriber device from a data store that is internal to the network by accessing a content location database that includes content location data for at least some of the multimedia content available through the network, and determining whether the content location data indicates that the requested multimedia content is available for delivery to the subscriber device from a data store that is internal to the network.

39. The network node of claim 38, wherein the processing circuit is further configured to maintain the content location database for at least a portion of the network, based on receiving indications from one or more network entities within the network as to which particular multimedia content is internally cached within the network and updating the content location database according to the received indications.

40. The network node of claim 39, wherein the processing circuit is configured to receive the indications from the one or more network entities based on at least one of: communicating with a cache management entity in the network and communicating with one or more radio base stations or base station controllers in the network.

41. The network node of claim 35, wherein the processing circuit is configured to determine the content location of the requested multimedia content by determining whether, in a first case, the requested multimedia content is not indicated as being internally available within the network for delivery to the subscriber device, or determining that, in a second case, the requested multimedia content is indicated as being internally available within the network for delivery to the subscriber device, and wherein the processing circuit is further configured to control the content location information included in the charging-related message to indicate whether the first case or the second case applies.

42. The network node of claim 41, wherein the processing circuit is configured to, in the second case, control the content location information to indicate whether the requested multimedia content is to be delivered to the subscriber device from a data store in a Radio Access Network, RAN, portion of the network or from a data store in a Core Network, CN, portion of the network.

43. The network node of claim 35, wherein, when the requested multimedia content is available internally within the network for delivery to the subscriber device, the processing circuit is configured to control the content location information in the charging-related message to indicate a cache identifier or location for the internal data store within the network from which the requested multimedia content is to be delivered.

44. The network node of claim 35, wherein the processing circuit is configured to generate the charging-related message as an accounting request message for a Charging Data Function, CDF, node as said charging node, or to generate the charging-related message as an credit control request message for an Online Charging System, OCS, node as said charging node.

45. A method at a charging node in a wireless communication network, said method comprising:
receiving a charging-related message incoming to the charging node from another node in the network, said charging related message comprising an accounting or credit-control request message associated with charging a subscriber account for requested multimedia content targeted for access by a subscriber device associated with the subscriber account;
determining whether content location information in the incoming charging-related message indicates that a content location of the requested multimedia content is internal to the network; and
generating charging-related data that is differentiated in dependence on whether the content location is internal to the network.

46. The method of claim 45, wherein generating charging-related data that is differentiated in dependence on whether the content location is internal to the network comprises generating the charging-related data according to a differentiated pricing structure where first rates or charges apply in the case that the content location is indicated as being internal to the network, and second rates or charges apply in the case that the content location is not indicated as being internal to the network.

47. The method of claim 45, further comprising, in the case that the content location is indicated as being internal to the network, generating the charging-related data so as to differentiate between the content location being internal to a Radio Access Network, RAN, portion of the network, or the content location being internal to a Core Network, CN, portion of the network.

48. A charging node configured for operation in a wireless communication network, said charging node comprising:
a communication interface configured to communicate with one or more other nodes in the network; and
a processing circuit operatively associated with the communication interface and configured to:
receive a charging-related message incoming to the charging node from another node in the network, said charging related message comprising an accounting or credit-control request message associated with charging a subscriber account for requested multimedia content targeted for access by a subscriber device associated with the subscriber account;
determine whether content location information in the incoming charging-related message indicates that a content location of the requested multimedia content is internal to the network; and
generate charging-related data that is differentiated in dependence on whether the content location is internal to the network.
